(19) United States
(12) Patent Application Publication
(10) Pub. No.: US 2016/0138744 A1
(43) Pub. Date: May 19, 2016

(54) QUICK COUPLING COMPRISING IMPROVED BALL BEARING

(71) Applicant: Faster S.p.A., Rivolta d'Adda (IT)

(72) Inventors: Igor Polgati, Agnadello (IT); Daniele Rossetti, Pandino (IT)

(21) Appl. No.: 14/946,092

(22) Filed: Nov. 19, 2015

(30) Foreign Application Priority Data
Nov. 19, 2014 (EP) 14193884.5

(51) Int. Cl. F16L 27/08; F16L 37/00; F16C 43/04; F16C 19/54

(52) U.S. Cl. CPC F16L 27/08; F16C 19/546; F16L 37/00; F16C 43/04

(57) ABSTRACT

The present invention relates to a female coupling of the screw type comprising a ball bearing which guarantees the rotation of the block intended to couple the male coupling with respect to the block which can be gripped by the user and connected to the line. In particular, the present invention is characterized in that said female coupling is configured so as to facilitate the assembly of the bearing in the female coupling. The female coupling according to the present invention is further characterized in that the bearing is maintainable by the end user.

### CROSS REFERENCE TO RELATED APPLICATION

This application claims priority to EP patent application No. 14193884.5, filed Nov. 19, 2014, which is incorporated herein by reference thereto.

### FIELD OF THE INVENTION

The present invention relates to a female quick coupling for pressurized fluids characterized in that it comprises an improved ball bearing.

More in particular, the quick coupling according to the present invention is of the type comprising at least two bodies, i.e. a first main block in which a second block is inserted and locked by means of a screw coupling, and the second block, in which the hydraulic line is axially defined, which comprises therein a plurality of components necessary for the operation and the fluid-dynamics of the coupling known in the prior art.

The first and the second block are free to turn with respect to each other about an axial symmetry axis to facilitate the coupling and uncoupling operations of the male coupling by the operator.

### BACKGROUND OF THE INVENTION

Quick screw couplings are known in the sector of quick couplings for the connection of hydraulic lines.

In this type of coupling, the female coupling comprises two blocks which can be turned with respect to each other about an axial rotation axis, so as to be able to facilitate the assembly and disassembly operations of the male coupling by the user.

FIGS. 1, 1A and FIGS. from 2A to 2F show a female screw coupling of the type known in the prior art and the steps of assembling the ball bearing components, respectively.

More in particular and with reference to the mentioned figures, the female coupling thus comprises at least one first block 10, which comprises, in turn, the ball body 11, and a second block 20, comprising an adapter body 21 and a plurality of other internal components, as known in the prior art.

A ball bearing, generically indicated with reference numeral 40, is provided between said first block 10 and said second block 20, which ball bearing comprises, in turn, a pair of slewing rings 41, 42 and a plurality of balls 43 inserted between said two slewing rings 41, 42.

Said two slewing rings are kept in position by a ring nut 30, which is interposed between said adapter 21 and said ball body 11. More in particular, according to the prior art, the ring nut 30 is attached to the ball body 11 by means of a threading, preferably with the addition of thread lock of the LOCTITE type which is used to prevent the undesired loosening of the ring nut 30 and thus the possible tampering of the bearing. In this manner, however, the bearing cannot be reached or even maintained by the user.

Moreover, an elastic ring 44 is provided to block the slewing rings with respect to the adapter body 21 further. The elastic ring 44 is preferably housed in a seat appropriately obtained in said adapter 21.

By virtue of the configuration illustrated above and the presence of the bearing 40, the adapter body may turn about the longitudinal axis of the coupling with respect to said ball bearing 11 in the female coupling of the type illustrated thereto.

The bearing 40 is protected from the dirt coming from the outside by virtue of the presence of an oil scraper ring 33 placed between said adapter 21 and said ring nut 30.

However, the bearing can be reached by the dirt coming from the inside of the coupling, i.e. from the left side of the bearing itself referring to the illustration shown in FIG. 1.

The female coupling and the bearing 40 of known type of the prior art have some drawbacks.

In particular, the configuration of the bearing 40, as currently in use and described thereto, which comprises a pair of slewing rings 41, 42, which retain a plurality of balls 43, has considerable manufacturing and assembly criticalities which negatively affect manufacturing time, and ultimately the cost-effectiveness of the product itself.

Firstly, it is worth noting that the slewing rings 41, 42 are obtained from a full steel bar for hardening and tempering, e.g. 39NiCrMo3. After processing with machine tools, in particular after turning, the part is subjected to grinding on magnets to prevent ovalizations, and is then subjected to a vacuum hardening thermal treatment, which further prevents the possibility of the bar of being deformed in service, and finally it is subjected to a surface treatment with ZnCrIII.

The slewing ring production process is thus very costly from the economic point of view in addition to being very long. The entire production process may take up to 5 weeks for the only manufacturing of the finished slewing rings ready for assembly.

However, the assembly process of the female coupling in itself of the type known in the prior art also causes criticalities.

Indeed, with particular reference to FIGS. from 2A to 2F, the steps of assembling of the bearing 40 are as follows.

The second block 20 with adapter 21 is placed with the end adapted to house the male coupling facing downwards, as shown in FIG. 2A.

As shown in FIG. 2B, the two slewing rings 41, 42 and the elastic ring 44 are inserted, and after this the worker manually inserts the balls inside the two slewing rings after having counted them with the aid of a ball counting tool specifically dimensioned to contain the number of balls necessary for the size of the coupling to be assembled. The situation is shown in FIG. 2D.

Being careful for not let the balls escape, the second block 20 is turned as shown in FIG. 2E and inserted in the first block 10 closing the coupling. The ring nut 30 is now inserted and screwed into the ball body 11, the thread is locked with LOCTITE, and tightened with a specific torque wrench to the predetermined torque value.

From the above, it is apparent that the assembly process of the bearing on the female coupling is a complex process, which must be performed entirely by hand and for which a high degree of attention, and consequently of specialization, is necessary. The step of assembling of the bearing considerably affects the overall time necessary for the assembly of the female coupling, and thus reducing the assembly times of the bearing allows to considerably reduce the time needed to manufacture the entire coupling.

### SUMMARY OF THE INVENTION

It is the main task of the present invention to provide a female screw coupling, i.e. of the screw type, i.e. of the type comprising a bearing which allows a relative rotation of two parts of the coupling about the longitudinal axis of the coupling, which allows to overcome the drawbacks which afflict the solutions of known type.

In the scope of this task, it is the object of the present invention to provide a female coupling which comprises an improved bearing, which allows the same sliding efficacy during the connection and disconnection of the male coupling as the solutions of known type, but which at the same time allows to considerably simplify the assembly operations of the bearing and to drastically reduce the time needed for the assembly of the bearing and thus of the coupling.

It is a further object of the present invention to provide a female screw coupling which comprises a bearing which is more protected from dirt in the conditions of use.

It is a further object of the present invention to provide a female coupling of the screw type which comprises a bearing which can be easily accessed by the user for maintenance operations.

This task and the other objects which will be more apparent from the description below are reached by a female coupling of the screw type as claimed in the accompanying claims which form an integral part of the present description.

### BRIEF DESCRIPTION OF THE DRAWINGS

Further features and advantages of the present invention will be more apparent in the following detailed description provided by way of non-limitative example and illustrated in the accompanying figures, in which:

FIG. 1 shows a vertical longitudinal plane section view of a female coupling of the type known in the prior art, to which the present invention refers;

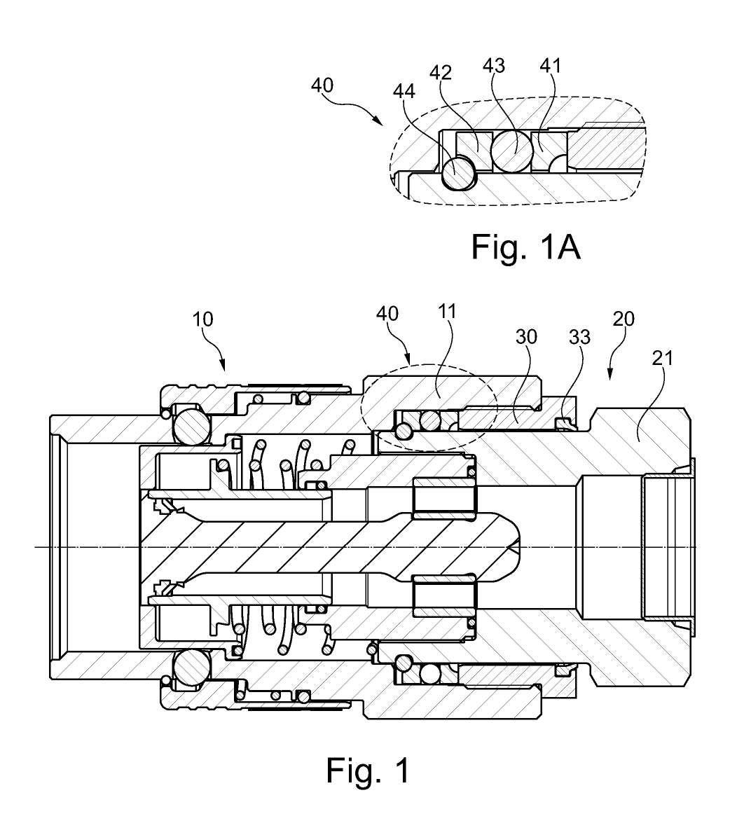

FIG. 1A shows a detail in FIG. 1, in particular it shows the bearing of known type according to the prior art;

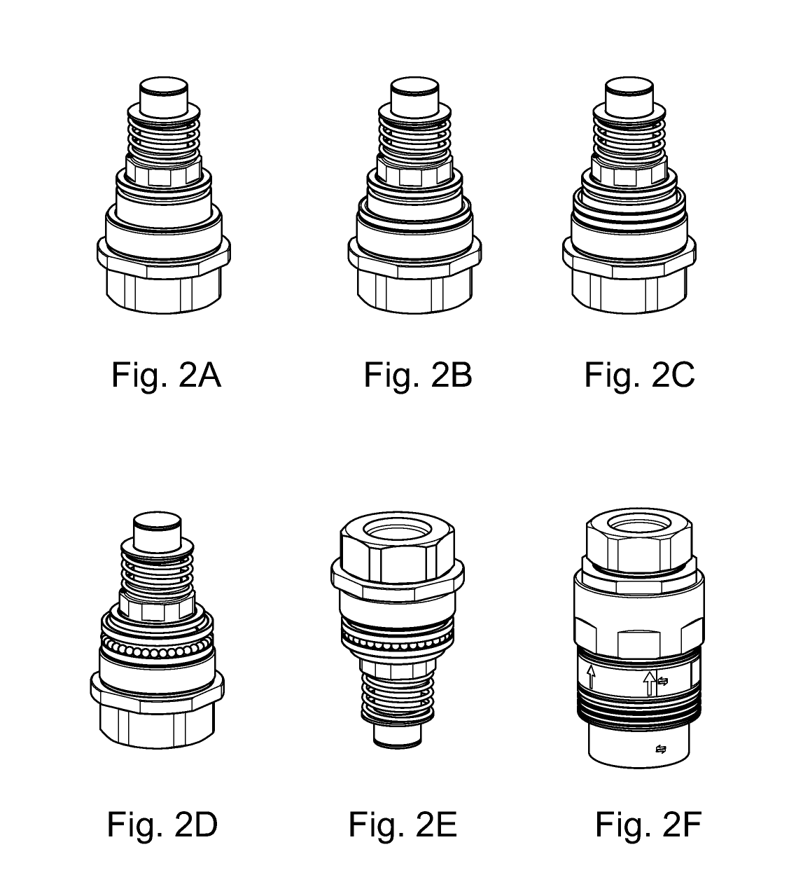

FIGS. 2A to 2F show the steps of assembling of the ball bearing of the known type on the coupling of known type;

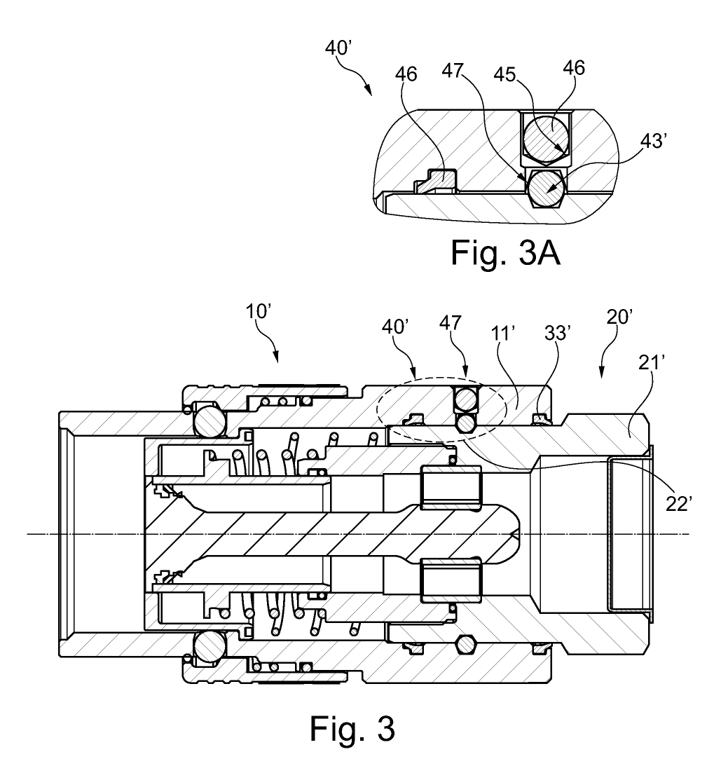

FIG. 3 shows a vertical longitudinal plane section view of a female coupling according to the present invention;

FIG. 3A shows a detail in FIG. 3, in particular it shows the bearing according to the present invention;

FIGS. from 4A to 4C show the steps of assembling the improved ball bearing on the female coupling according to the present invention.

### DETAILED DESCRIPTION OF THE INVENTION

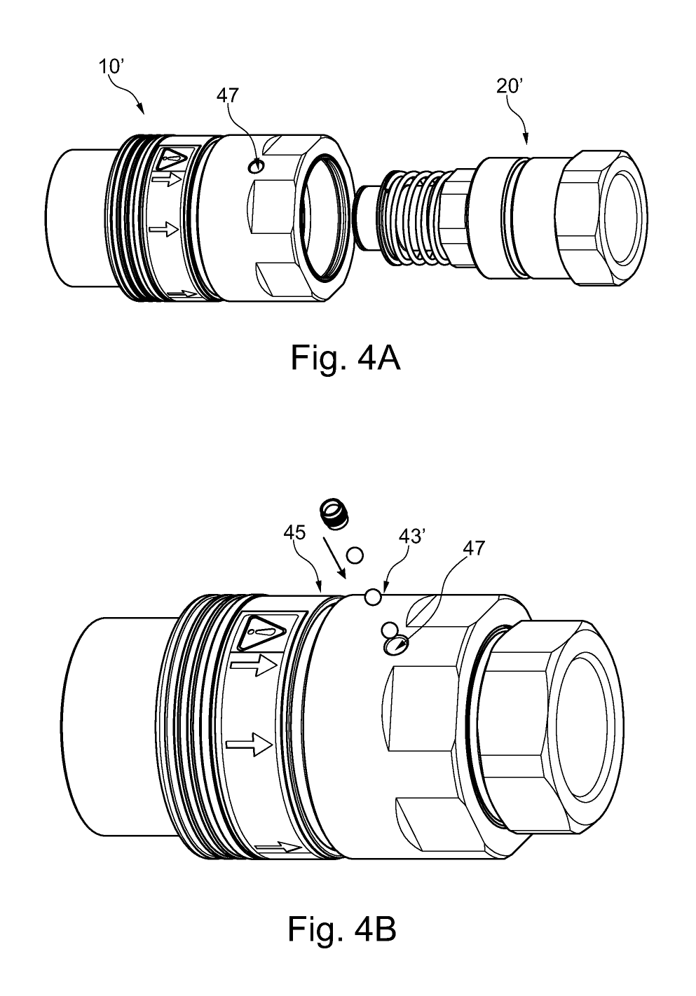

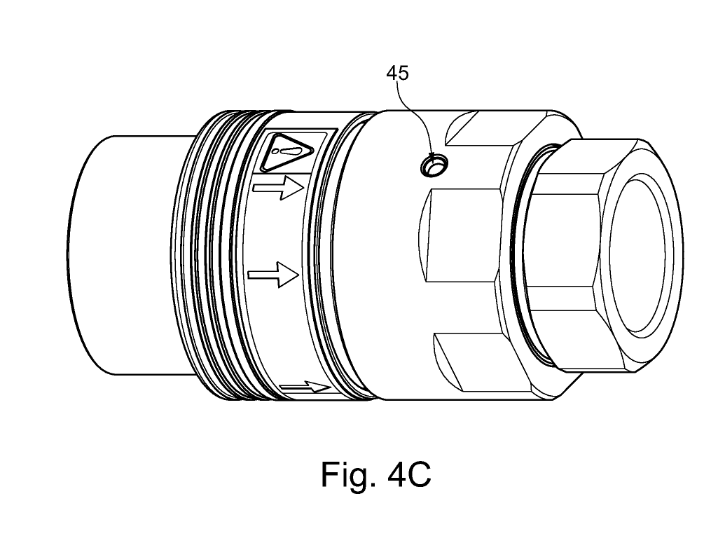

With reference in particular to appended FIG. 3 and to the detail in FIG. 3A, the female coupling according to the present invention is of the type comprising a first block 10′, which comprises, in turn, a ball body 11′, and a second block 20′, comprising an adapter body 21′.

A ball bearing, generically indicated by reference numeral 40′, which comprises, in turn, a plurality of balls 43′,is provided between said first block 10′ and said second block 20′.

A housing recess 22′ of said balls 43′ is appropriately provided on the outer surface of said adapter body 21′.

Advantageously, said recess 22, which circumferentially crosses said adapter body 21′, is thermally treated by means of an induction hardening process so as to avoid any wear phenomena caused by friction.

As apparent from the section in FIG. 3, and in particular in FIG. 3A, the bearing 40′of the coupling according to the present invention does not require ball bearing slewing rings.

Similarly, the female coupling according to the present invention does not require the ring nut 30 which is needed, in the solution of known type, between said ball body 11 and said adapter body 21, and similarly the elastic ring 44 which locked the bearing in position is eliminated.

A radial through hole 47 is appropriately provided in said ball body 11′ in order to allow inserting the bearing balls 43′ in their seat.

The diameter of said through hole 47 may be slightly larger than the diameter of the balls 43′ and the through hole is closed by closing means 45.

Said closing means of said through hole 47 may advantageously consist of an expander type plug 45, of known type, which is kept in seat by interference by inserting a ball 46, thus keeping the balls 43′ in their seat at the same time.

As described thereto, the female coupling according to the present invention thus comprises a bearing of improved type which implies many advantages.

A first advantage is that the bearing no longer requires slewing rings, which translates into lower manufacturing costs, and which also allows to reduce the final cost of the coupling for the user and/or to increase the profit margin of the product.

A second advantage again linked to the elimination of the slewing ring is given by the shorter time needed for manufacturing the coupling because the long manufacturing times of the slewing rings are eliminated.

A further advantage consists in simplifying the assembly operations because the bearing is assembled once the coupling is already assembled, i.e. when the second block 20′ comprising said adapter 21′ has already been inserted in said first block 10′ comprising said ball body 11′, simply by inserting the balls 43′ through said through hole 47.

The balls are counted with the aid of a tool specifically dimensioned to contain the number needed for the size of the coupling to be assembled through the radial through hole 47.

The radial hole 47 is thus closed by closing the expander plug 45 which is forced into the ball body 11′, in particular into said radial hole 47, by means of a specific punch.

The sequence of the steps of assembling is shown in FIGS. 4A-4C.

With reference to the detail in FIG. 3A a second oil scraper 46 operating again between said ball bearing 11′ and said adapter 21′ and placed with respect to the bearing 40′ towards the end of said adapter 21′, in addition to a first oil scraper 33′ operating between said ball body 11′ and said adapter 21′ and placed, with respect to the bearing 40′, towards the opposite end of said coupling, are further provided on said ball body 11′.

By virtue of the presence of the two oil scrapers 33′, 46, the bearing 40′ is protected from the dirt coming from the outside and from the inside of the coupling itself.

By virtue of the improved bearing 40′ described hereto, the female coupling according to the present invention reaches the set task and objects.

More in detail, sensitivity to dirt is improved while maintaining the sliding features during the steps of connecting and disconnecting of the male coupling unchanged, thus simultaneously solving, as shown, the criticalities during the step of manufacturing, in particular by enormously simplifying the steps of assembling of the bearing itself, with the considerable advantages of abbreviating manufacturing times and of reducing the number of components, and, consequently, of improving manufacturing cost-effectiveness, and in terms of improved operative conditions of the assembly operators, which require a lower level of attention, and thus imply a lower stress level and better movement ergonomics.

Not last, the bearing of the coupling according to the invention can be easily maintained by the end user simply by removing the expander plug without needing to disassemble the coupling, even partially.

1. A female screw coupling of the type comprising a first block, which comprises, in turn, a ball body, and a second block, which comprises, in turn, an adapter body for the quick connection to a male coupling, and further comprising a ball bearing being interposed between said first block and said second block to allow the relative rotation of said first block and said second block, the female screw coupling comprising a radial through hole in said ball body adapted to allow the insertion of the balls of said ball bearing in their operative position.

2. A female coupling according to claim 1, wherein said adapter body comprises at least one recess at the outer surface thereof and at said radial through hole, which circumferentially crosses the outer diameter of said adapter and adapted to at least partially house said balls.

3. A female coupling according to claim 2, further comprising closing means for closing said through hole.

4. A female coupling according to claim 3, wherein said closing means comprises an expander plug.

5. A female coupling according to claim 4, further comprising a first oil scraper operating between said ball bearing and said adapter and placed with respect to the bearing towards the end of said adapter intended to couple with a male coupling, and a second oil scraper, again operating between said ball body and said adapter and placed, with respect to the bearing, towards the opposite end of said coupling on said ball body.

6. An assembly method of a female screw coupling of the type comprising a first block, which comprises, in turn, a ball body, and a second block, which comprises, in turn, an adapter body for the quick connection to a male coupling, and further comprising a ball bearing interposed between said first block and said second block to allow the relative rotation of said first block and said second block, comprising a radial through hole in said ball body adapted to allow to insert the balls of said ball bearing, the method comprising the steps of:
assembling said first block and said second block to each other;
once the female coupling is assembled, inserting the balls of said ball bearing through said radial through hole;
closing said through hole by means of closing means.
